(19) United States
(12) Patent Application Publication
(10) Pub. No.: US 2017/0326684 A1
(43) Pub. Date: Nov. 16, 2017

(54) LASER MARKING HEAD AND LASER MARKING MACHINE

(71) Applicant: MAXPHOTONICS CORPORATION, Shenzhen (CN)

(72) Inventors: Jian Ju, Shenzhen (CN); Feng Jiang, Shenzhen (CN)

(21) Appl. No.: 15/654,587

(22) Filed: Jul. 19, 2017

Related U.S. Application Data
(63) Continuation of application No. PCT/CN2016/071443, filed on Jan. 20, 2016.

(30) Foreign Application Priority Data
Jan. 21, 2015 (CN) 201510028354.1

(51) Int. Cl. B23K 26/08; B23K 26/10; B23K 26/04; B23K 26/062; B23K 26/00; B23K 26/70; B23K 26/36; B23K 26/06

(52) U.S. Cl. CPC B23K 26/0869; B23K 26/36; B23K 26/10; B23K 26/0648; B23K 26/062; B23K 26/009; B23K 26/70; B23K 26/048

(57) ABSTRACT

A laser marking head and a laser marking machine are disclosed. The laser marking head includes: a laser generator, the laser generator being configured to emit laser; a first guide rail; a first sliding device, the first sliding device being sleeved on and being capable of sliding on the first guide rail; a first reflector, the first reflector being positioned on the first sliding device; a second guide rail, the second guide rail being fixed on the first sliding device and being perpendicular to the first guide rail; a second sliding device, the second sliding device being sleeved on and being capable of sliding on the second guide rail; and a second reflector, the second reflector being positioned on the second sliding device.

### CROSS-REFERENCE TO RELATED APPLICATIONS

The present disclosure claims priority to Chinese Patent Application No. 201510028354.1, filed with the Chinese Patent Office on Jan. 21, 2015, titled “METHOD FOR CONTROLLING LASER MARKING, LASER MARKING HEAD, AND LASER MARKING MACHINE”, the entire contents of which are incorporated herein by reference.

### TECHNICAL FIELD

The present disclosure relates to the field of laser control, and more particularly, to a laser marking head and a laser marking machine.

### BACKGROUND

Laser marking machine refers to devices that employ laser beams to irradiate objects to evaporate the surface layer and expose the deep layer thereof, so as to engrave patterns, brands, characters on the surface of the objects. Based on the generation modes of the laser, laser marking machine is mainly divided into: carbon dioxide laser marking machine, semiconductor laser marking machine, fiber laser marking machine, or the like.

In order to engrave exquisite markings on the surface of the objects, it is necessary to accurately control the irradiation position of the laser output from the laser marking head of the laser marking machine on the objects. In the prior art, the laser emitted from the laser generator in the laser marking head is incident on two reflectors, and controlling the reflection angles of the reflectors can deflect the laser beams, thus controlling the irradiation position of the laser on the objects.

### SUMMARY

An embodiment of the present disclosure provides a laser marking head. The laser marking head includes:

a laser generator, the laser generator being configured to emit laser;

a first guide rail;

a first sliding device, the first sliding device being sleeved on and being capable of sliding on the first guide rail;

a first reflector, the first reflector being positioned on the first sliding device;

a second guide rail, the second guide rail being fixed on the first sliding device and being perpendicular to the first guide rail;

a second sliding device, the second sliding device being sleeved on and being capable of sliding on the second guide rail; and

a second reflector, the second reflector being positioned on the second sliding device;

wherein, in use, the laser emitted from the laser generator is parallel to the first guide rail and incident on the first reflector, the first reflector reflects the laser to the second reflector, the laser reflected from the first reflector is parallel to the second guide rail, and the second reflector reflects the laser downward for location and marking.

Another embodiment of the present disclosure provides a laser marking head. The laser marking head includes:

a first guide rail;

a first sliding device, the first sliding device being sleeved on and being capable of sliding on the first guide rail;

a second guide rail, the second guide rail being fixed on the first sliding device and being perpendicular to the first guide rail;

a second sliding device, the second sliding device being sleeved on and being capable of sliding on the second guide rail;

a laser generator; and

a reflector, both the reflector and the laser generator being positioned on the second sliding device;

wherein, in use, laser emitted from the laser generator is incident on the reflector, and the reflector reflects the laser downward for location and marking.

Still another embodiment of the present disclosure provides a laser marking machine. The laser marking machine includes: a supporting rack, a marking platform, and a laser marking head;

the laser marking head including:

a laser generator, the laser generator being configured to emit laser;

a first guide rail;

a first sliding device, the first sliding device being sleeved on and being capable of sliding on the first guide rail;

a first reflector, the first reflector being positioned on the first sliding device;

a second guide rail, the second guide rail being fixed on the first sliding device and being perpendicular to the first guide rail;

a second sliding device, the second sliding device being sleeved on and being capable of sliding on the second guide rail; and

a second reflector, the second reflector being positioned on the second sliding device;

wherein, in use, the laser emitted from the laser generator is parallel to the first guide rail and incident on the first reflector, the first reflector reflects the laser to the second reflector, the laser reflected from the first reflector is parallel to the second guide rail, and the second reflector reflects the laser downward for location and marking;

the marking platform is configured to support an object to be marked, both the laser marking head and the marking platform are positioned on the supporting rack, the laser marking head is positioned above the marking platform, and the laser emitted downward from the laser marking head is incident on the marking platform.

Still another embodiment of the present disclosure provides a laser marking machine. The laser marking machine includes: a supporting rack, a marking platform, and a laser marking head;

the laser marking head including:

a first guide rail;

a first sliding device, the first sliding device being sleeved on and being capable of sliding on the first guide rail;

a second guide rail, the second guide rail being fixed on the first sliding device and being perpendicular to the first guide rail;

a second sliding device, the second sliding device being sleeved on and being capable of sliding on the second guide rail;

a laser generator; and

a reflector, both the reflector and the laser generator being positioned on the second sliding device;

wherein, in use, laser emitted from the laser generator is incident on the reflector, and the reflector reflects the laser downward for location and marking;

the marking platform is configured to support an object to be marked, both the laser marking head and the marking platform are positioned on the supporting rack, the laser marking head is positioned above the marking platform, and the laser emitted downward from the laser marking head is incident on the marking platform.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a laser marking head in accordance with one embodiment of the present disclosure;

FIG. 2 is a schematic diagram of a laser marking head in accordance with another embodiment of the present disclosure;

FIG. 3 is a schematic diagram of a laser marking machine in accordance with one embodiment of the present disclosure; and

FIG. 4 is a flow chart of a method for controlling laser marking in accordance with one embodiment of the present disclosure.

### DETAILED DESCRIPTION

Detailed description for embodiments of the present disclosure will be given below in conjunction with accompanying drawings.

As shown in FIG. 1, a laser marking head 20 includes a laser generator 21, a first guide rail 22, a first sliding device 23, a first reflector 24, a second guide rail 25, a second sliding device 26, and a second reflector 27.

The first sliding device 23 is sleeved on and is capable of sliding on the first guide rail 22. The first reflector 24 is positioned on the first sliding device 23. The second guide rail 25 is fixed on the first sliding device 23 and is perpendicular to the first guide rail 22. The second sliding device 26 is sleeved on and is capable of sliding on the second guide rail 25. The second reflector 27 is positioned on the second sliding device 26. The laser emitted from the laser generator 21 is parallel to the first guide rail 22 and incident on the first reflector 24. The first reflector 24 reflects the laser to the second reflector 27. The laser reflected from the first reflector 24 is parallel to the second guide rail 25, and the second reflector 27 reflects the laser downward for location and marking.

It should be noted that, the second guide rail 25 is perpendicular to the first guide rail 22, which means, analogously, the first guide rail 22 and the second guide rail 25 are corresponding to Y axis and X axis in a plane. Because the second guide rail 25 is fixed on the first sliding device 23, the sliding of the first sliding device 23 on the first guide rail 22 can synchronously adjust the coordinates of the first reflector 24 and the second reflector 27 on the Y axis, the sliding of the second sliding device 26 on the second guide rail 25 can adjust the coordinates of the second reflector 27 on the X axis, thus adjusting the coordinates of the laser emitted from the second reflector 27 on the X axis and Y axis, and then adjusting the marking coordinates of the laser marking head 20.

In addition, because the laser emitted from the laser generator 21 is parallel to the first guide rail 22, when the first sliding device 23 drives the first reflector 24 to slide on the first guide rail 22, the laser emitted from the laser generator 21 is consistently incident on the first reflector 24, and the incident angle of the laser on the first reflector 24 is constant, so that the reflection angle of the laser on the first reflector 24 is constant. Furthermore, because the first reflector 24 and the second reflector 27 synchronously move in the same direction, the laser reflected from the first reflector 24 is consistently incident on the second reflector 27. Likewise, the laser reflected from the first reflector 24 is parallel to the second guide rail 25, when the second sliding device 26 drives the second reflector 27 to slide on the second guide rail 25, the laser reflected from the first reflector 24 is consistently incident on the second reflector 27, and the incident angle of the laser is constant.

In some embodiments, the first sliding device 23 includes a first stepper motor 231 and a first sliding block 232. The second sliding device 26 includes a second stepper motor 261 and a second sliding block 262. The first guide rail 22, the first sliding block 232, the second guide rail 25, the second sliding block 262 are all provided with screw threads 60. The first guide rail 22 is fixed on the first stepper motor 231. The first sliding block 232 and the first guide rail 22 are in threaded connection. The first stepper motor 231 is configured to drive the first guide rail 22 to rotate so as to mobilize the first sliding block 232 to slide on the first guide rail 22. The second stepper motor 261 is fixed on the first sliding block 232. The second guide rail 25 is fixed on the second stepper motor 261. The second sliding block 262 and the second guide rail 25 are in threaded connection. The second stepper motor 261 is configured to drive the second guide rail 25 to rotate so as to mobilize the second sliding block 262 to slide on the second guide rail 25.

Undoubtedly, the sliding modes of the first sliding device 23 on the first guide rail 22 and the second sliding device 26 on the second guide rail 25 are not limited to the aforesaid modes. For example, both the first guide rail 22 and the second guide rail 25 are a groove, and the first sliding device 23 and the second sliding device 26 slide in the groove.

In some embodiments, the inner sides of the first sliding device 23 and the second sliding device 26 are provided with grating rulers 50. The displacement distances of the first reflector 24 and the second reflector 27 can be measured by the grating rulers 50.

In some embodiments, the first guide rail 22 and the second guide rail 25 are provided with the grating rulers. The displacement distances of the first sliding block 232 and the second sliding block 262 are measured by the grating rulers, to know the displacement distances of the first reflector 24 and the second reflector 27.

In some embodiments, the laser marking head 20 further includes a focusing lens 28, a collimator 29 and a housing (not shown in the drawings).

The focusing lens 28 is positioned at the lower part of the second sliding device 26, and the focusing lens 28 and the second reflector 27 move synchronously. In some embodiments, the focusing lens 28 is located below the second reflector 27, and is configured to focus the laser reflected from the second reflector 27. The collimator 29 is positioned between the laser generator 21 and the first reflector 24, and is configured to collimate the laser emitted from the laser generator 21 into parallel beams.

The first stepper motor 231 is fixed on the inner surface of the housing, and the laser generator 21 and the collimator 29 are fixed on the inner surface of the housing, or on one end of the first guide rail 22 away from the first stepper motor 231. The housing defines an opening (not shown in the drawings), the laser reflected from the second reflector 27 is emitted from the opening. In some embodiments, the housing may include a lens (not shown in the drawings) positioned at the opening.

In this embodiment of the present disclosure, the first sliding device and the second sliding device are capable of sliding on the first guide rail and the second guide rail, respectively. The first reflector and the second reflector are positioned on the first sliding device and the second sliding device, respectively. The laser emitted from the laser generator is parallel to the first guide rail and incident on the first reflector. The laser reflected from the first reflector is parallel to the second guide rail and is reflected to the second reflector. The second reflector reflects the laser downward. The sliding of the first sliding device on the first guide rail can synchronously adjust the coordinates of the first reflector and the second reflector on the Y axis, the sliding of the second sliding device on the second guide rail can adjust the coordinates of the second reflector on the X axis, thus adjusting the coordinates of the laser emitted from the second reflector on the X axis and Y axis, and then adjusting the marking coordinates of the laser marking head. Compared with conventional control methods, that is, adjusting the output point positions of the laser emitted from the laser marking head by controlling the reflection angle of the reflectors, the laser marking head of the embodiments of the present disclosure is small in size, and can execute marking operations in a large range and large span.

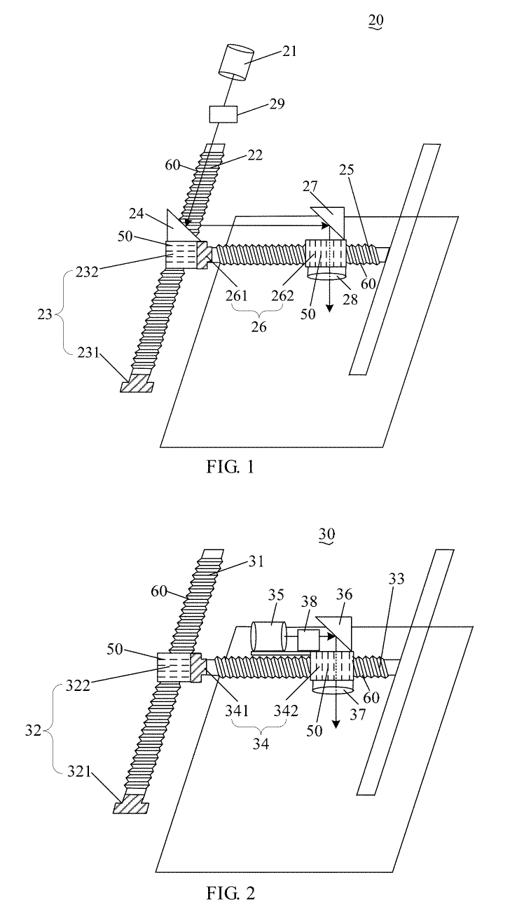

As shown in FIG. 2, the laser marking head 30 includes a first guide rail 31, a first sliding device 32, a second guide rail 33, a second sliding device 34, a laser generator 35, and a reflector 36.

The first sliding device 32 is sleeved on and is capable of sliding on the first guide rail 31. The second guide rail 33 is fixed on the first sliding device 32 and is perpendicular to the first guide rail 31. The second sliding device 34 is sleeved on and is capable of sliding on the second guide rail 33. Both the reflector 36 and the laser generator 35 are fixed on the second sliding device 34. The laser emitted from the laser generator 35 is incident on the reflector 36, and the reflector 36 reflects the laser downward for location and marking.

It should be noted that, the sliding of the second guide rail 33 with the sliding of the first sliding device 32 adjusts the coordinates of the second guide rail 33 on the Y axis, thus adjusting the coordinates of the reflector 36 on the Y axis; the sliding of the second sliding device 34 on the second guide rail 33 adjusts the coordinates of the reflector 36 on the X axis; thus adjusting the coordinates of the laser marking head 30.

In some embodiments, the first sliding device 32 includes a first stepper motor 321 and a first sliding block 322. The second sliding device 34 includes a second stepper motor 341 and a second sliding block 342. The first guide rail 31, the first sliding block 322, the second guide rail 33, the second sliding block 342 are all provided with screw threads 60. The first guide rail 31 is fixed on the first stepper motor 321. The first sliding block 322 and the first guide rail 31 are in threaded connection. The first stepper motor 321 is configured to drive the first guide rail 31 to rotate so as to mobilize the first sliding block 322 to slide on the first guide rail 31. The second stepper motor 321 is fixed on the first sliding block 322. The second guide rail 33 is fixed on the second stepper motor 341. The second sliding block 342 and the second guide rail 33 are in threaded connection. The second stepper motor 341 is configured to drive the second guide rail 33 to rotate so as to mobilize the second sliding block 342 to slide on the second guide rail 33.

Undoubtedly, the sliding modes of the first sliding device 32 on the first guide rail 31 and the second sliding device 34 on the second guide rail 33 are not limited to the aforesaid modes. For example, both the first guide rail 31 and the second guide rail 33 are a groove, and the first sliding device 32 and the second sliding device 34 slide in the groove.

In some embodiments, the inner sides of the first sliding device 32 and the second sliding device 34 are provided with grating rulers 50. The displacement distances of the reflector 36 can be measured by the grating rulers 50.

In some embodiments, the first guide rail 31 and the second guide rail 33 are provided with the grating rulers. The displacement distances of the first sliding block 322 and the second sliding block 342 are measured by the grating rulers, to know the displacement distances of the reflector 36.

In some embodiments, the laser marking head 30 further includes a focusing lens 37 and a collimator 38. The focusing lens 37 is positioned on the second sliding device 34, and the focusing lens 37 and the reflector 36 move synchronously. In some embodiments, the focusing lens 37 is located below the reflector 36, and is configured to focus the laser reflected from the reflector 36. The collimator 38 is positioned between the laser generator 35 and the reflector 36, and is configured to collimate the laser emitted from the laser generator 35 into parallel beams.

In this embodiment of the present disclosure, the second guide rail is fixed on the first sliding device. When the first sliding device slides on the first guide rail, the second guide rail moves along with the first sliding device, thus adjusting the coordinates of the second guide rail on the Y axis, and then adjusting the coordinates of the reflector on the Y axis; the sliding of the second sliding device on the second guide rail adjust the coordinates of the reflector on the X axis, thus adjusting the coordinates of the laser marking head. Compared with conventional control methods, that is, adjusting the output point positions of the laser emitted from the laser marking head by controlling the reflection angle of the reflectors, the laser marking head of the embodiment of the present disclosure is small in size, and can execute marking operations in a large range and large span.

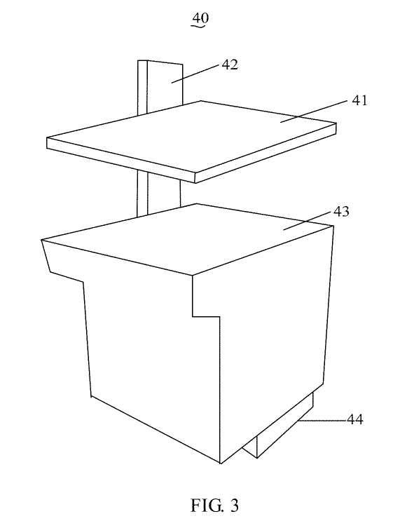

As shown in FIG. 3, a laser marking machine 40, includes: a laser marking head 41, a supporting rack 42, and a marking platform 43. The marking platform 43 is configured to support an object to be marked. Both the laser marking head 41 and the marking platform 43 are fixed on the supporting rack 42. The laser marking head 41 is positioned above the marking platform 43. The laser emitted downward from the laser marking head 41 is incident on the marking platform 43, so as to mark the object to be marked.

It should be noted that, the structure of the laser marking head 41 can refer to the aforesaid embodiments, so it is unnecessary to repeat here. Furthermore, the first guide rail of the laser marking head 41 is parallel to Y axis of the marking platform; the second guide rail of the laser marking head 41 is parallel to X axis of the marking platform; and the laser emitted downward from the laser marking head 41 is perpendicular to the marking platform 43.

The laser marking machine 40 further includes a lifting device 44, and the lifting device 44 is positioned on the supporting rack 42. The marking platform 43 is positioned on the lifting device 44, and the lifting device 44 is configured to raise or lower the marking platform 43.

In one embodiment of the present disclosure, the first sliding device and the second sliding device are capable of sliding on the first guide rail and the second guide rail, respectively. The first reflector and the second reflector are positioned on the first sliding device and the second sliding device, respectively. The laser emitted from the laser generator is parallel to the first guide rail and incident on the first reflector. The laser reflected from the first reflector is parallel to the second guide rail and is reflected to the second reflector. The second reflector reflects the laser downward. The sliding of the first sliding device on the first guide rail can synchronously adjust the coordinates of the first reflector and the second reflector on the Y axis, the sliding of the second sliding device on the second guide rail can adjust the coordinates of the second reflector on the X axis, thus adjusting the coordinates of the laser emitted from the second reflector on the X axis and Y axis, and then adjusting the marking coordinates of the laser marking head. Compared with conventional control methods, that is, adjusting the output point positions of the laser emitted from the laser marking head by controlling the reflection angle of the reflectors, the laser marking head of the embodiments of the present disclosure is small in size, and can execute marking operations in a large range and large span.

In another embodiment of the present disclosure, the second guide rail is fixed on the first sliding device. When the first sliding device slides on the first guide rail, the second guide rail moves along with the first sliding device, thus adjusting the coordinates of the second guide rail on the Y axis, and then adjusting the coordinates of the reflector on the Y axis; the sliding of the second sliding device on the second guide rail adjust the coordinates of the reflector on the X axis, thus adjusting the coordinates of the laser marking head. Compared with conventional control methods, that is, adjusting the output point positions of the laser emitted from the laser marking head by controlling the reflection angle of the reflectors, the laser marking head of the embodiment of the present disclosure is small in size, and can execute marking operations in a large range and large span.

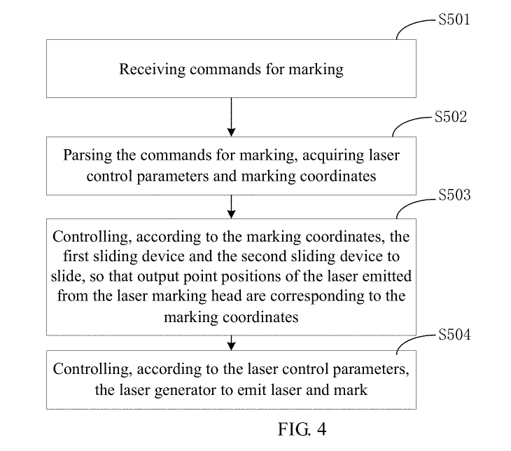

The embodiment of the present disclosure further provides an implementation mode illustrating a method for controlling laser marking. As shown in FIG. 4, the method includes:

providing a laser marking machine, the laser marking machine comprising a laser marking head, the laser marking head comprising:

a laser generator, the laser generator being configured to emit laser;

a first guide rail;

a first sliding device, the first sliding device being sleeved on and being capable of sliding on the first guide rail;

a first reflector, the first reflector being positioned on the first sliding device;

a second guide rail, the second guide rail being fixed on the first sliding device and being perpendicular to the first guide rail;

a second sliding device, the second sliding device being sleeved on and being capable of sliding on the second guide rail; and

a second reflector, the second reflector being positioned on the second sliding device;

S501: A command for marking is received;

The command for marking is used to instruct to perform laser marking.

S502: The command for marking is parsed, laser control parameters and marking coordinates are acquired.

The laser control parameters including marking power, laser frequency, pulse width, control parameters of the first reflector, and control parameters of the second reflector.

In some embodiments, the laser control parameters are used to control the laser generator to output satisfactory laser. The marking power ranges from 1-20. The laser frequency is adjustable, and the value thereof is determined by the specific marking materials, which ranges from 25-60 Khz. The pulse width ranges from 80-140 ns or 4-260 ns, the pulse width of Q-switched lasers ranges from 80-140 ns, and the pulse width of MOPA tunable lasers ranges from 4-260 ns. The control parameters of the first reflector and the control parameters of the second reflector are determined by the incident angle. The marking coordinates refer to the positions for laser marking.

S503: The first sliding device and the second sliding device are controlled to slide according to the marking coordinates, so that output point positions of the laser emitted from the laser marking head are corresponding to the marking coordinates; and

S504: The laser generator is controlled to emit laser for marking according to the laser control parameters.

The detailed structure of the laser marking head can refer to the aforesaid embodiments, so it is unnecessary to repeat here.

In the embodiment of the present disclosure, the first sliding device and the second sliding device are capable of sliding on the first guide rail and the second guide rail, respectively. The first reflector and the second reflector are positioned on the first sliding device and the second sliding device, respectively. The laser emitted from the laser generator is parallel to the first guide rail and incident on the first reflector. The laser reflected from the first reflector is parallel to the second guide rail and is reflected to the second reflector. The second reflector reflects the laser downward. The sliding of the first sliding device on the first guide rail can synchronously adjust the coordinates of the first reflector and the second reflector on the Y axis, the sliding of the second sliding device on the second guide rail can adjust the coordinates of the second reflector on the X axis, thus adjusting the coordinates of the laser emitted from the second reflector on the X axis and Y axis, and then adjusting the marking coordinates of the laser marking head. Compared with conventional control methods, that is, adjusting the output point positions of the laser emitted from the laser marking head by controlling the reflection angle of the reflectors, the laser marking head of the embodiments of the present disclosure is small in size, and can execute marking operations in a large range and large span.

Another embodiment of the present disclosure further provides an implementation mode illustrating a method for controlling laser marking. As shown in FIG. 4, the method includes:

providing a laser marking machine, the laser marking machine comprising a laser marking head, the laser marking head comprising:

a first guide rail;

a first sliding device, the first sliding device being sleeved on and being capable of sliding on the first guide rail;

a second guide rail, the second guide rail being fixed on the first sliding device and being perpendicular to the first guide rail;

a second sliding device, the second sliding device being sleeved on and being capable of sliding on the second guide rail;

a laser generator; and

a reflector, both the reflector and the laser generator being fixed on the second sliding device;

S501: A command for marking is received;

The command for marking is used to instruct to perform laser marking.

S502: The command for marking is parsed, laser control parameters and marking coordinates are acquired.

The laser control parameters including marking power, laser frequency, pulse width, control parameters of the reflector.

In some embodiments, the laser control parameters are used to control the laser generator to output satisfactory laser. The marking power ranges from 1-20. The laser frequency is adjustable, and the value thereof is determined by the specific marking materials, which ranges from 25-60 Khz. The pulse width ranges from 80-140 ns or 4-260 ns, the pulse width of Q-switched lasers ranges from 80-140 ns, and the pulse width of MOPA tunable lasers ranges from 4-260 ns. The control parameters of the first reflector and the control parameters of the second reflector are determined by the incident angle. The marking coordinates refer to the positions for laser marking.

S503: The first sliding device and the second sliding device are controlled to slide according to the marking coordinates, so that output point positions of the laser emitted from the laser marking head are corresponding to the marking coordinates; and

S504: The laser generator is controlled to emit laser for marking according to the laser control parameters.

The detailed structure of the laser marking head can refer to the aforesaid embodiments, so it is unnecessary to repeat here.

In the embodiment of the present disclosure, the second guide rail is fixed on the first sliding device. When the first sliding device slides on the first guide rail, the second guide rail moves along with the first sliding device, thus adjusting the coordinates of the second guide rail on the Y axis, and then adjusting the coordinates of the reflector on the Y axis; the sliding of the second sliding device on the second guide rail adjust the coordinates of the reflector on the X axis, thus adjusting the coordinates of the laser marking head. Compared with conventional control methods, that is, adjusting the output point positions of the laser emitted from the laser marking head by controlling the reflection angle of the reflectors, the laser marking head of the embodiment of the present disclosure is small in size, and can execute marking operations in a large range and large span.

Finally it shall be noted that, the above embodiments are only used to describe but not to limit the technical solutions of the present disclosure; and within the concept of the present disclosure, technical features of the above embodiments or different embodiments may also be combined with each other, the steps may be implemented in an arbitrary order, and many other variations in different aspects of the present disclosure described above are possible although, for purpose of simplicity, they are not provided in the details. Although the present disclosure has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not depart from the scope of the present disclosure due to such modifications or substations.

What is claimed is:

1. A laser marking head, comprising:
a laser generator, the laser generator being configured to emit laser;
a first guide rail;
a first sliding device, the first sliding device being sleeved on and being capable of sliding on the first guide rail;
a first reflector, the first reflector being positioned on the first sliding device;
a second guide rail, the second guide rail being fixed on the first sliding device and being perpendicular to the first guide rail;
a second sliding device, the second sliding device being sleeved on and being capable of sliding on the second guide rail; and
a second reflector, the second reflector being positioned on the second sliding device;
wherein, in use, the laser emitted from the laser generator is parallel to the first guide rail and incident on the first reflector, the first reflector reflects the laser to the second reflector, the laser reflected from the first reflector is parallel to the second guide rail, and the second reflector reflects the laser downward for location and marking.

2. The laser marking head according to claim 1, wherein
the laser marking head further comprises a focusing lens; and
the focusing lens is positioned on the second sliding device and located below the second reflector, and the focusing lens is configured to focus the laser reflected from the second reflector.

3. The laser marking head according to claim 1, wherein
the laser marking head further comprises a collimator; and
the collimator is positioned between the laser generator and the first reflector, and is configured to collimate the laser emitted from the laser generator into parallel beams.

4. The laser marking head according to claim 1, wherein
the first sliding device comprises a first stepper motor and a first sliding block, and both the first sliding block and the first guide rail are provided with screw threads;
the first guide rail is fixed on the first stepper motor, the first sliding block and the first guide rail are in threaded connection, and the first stepper motor is configured to drive the first guide rail to rotate so as to mobilize the first sliding block to slide on the first guide rail;
the second sliding device comprises a second stepper motor and a second sliding block, and both the second sliding block and the second guide rail are provided with screw threads; and
the second stepper motor is fixed on the first sliding block, the second guide rail is fixed on the second stepper motor, the second sliding block and the second guide rail are in threaded connection, and the second stepper motor is configured to drive the second guide rail to rotate so as to mobilize the second sliding block to slide on the second guide rail.

5. A laser marking head, comprising:
a first guide rail;
a first sliding device, the first sliding device being sleeved on and being capable of sliding on the first guide rail;
a second guide rail, the second guide rail being fixed on the first sliding device and being perpendicular to the first guide rail;
a second sliding device, the second sliding device being sleeved on and being capable of sliding on the second guide rail;
a laser generator; and
a reflector, both the reflector and the laser generator being positioned on the second sliding device;
wherein, in use, laser emitted from the laser generator is incident on the reflector, and the reflector reflects the laser downward for location and marking.

6. The laser marking head according to claim 5, wherein
the laser marking head further comprises a focusing lens; and
the focusing lens is positioned on the second sliding device and located below the reflector, and is configured to focus the laser reflected from the reflector.

7. The laser marking head according to claim 5, wherein
the first sliding device comprises a first stepper motor and a first sliding block, and both the first sliding block and the first guide rail are provided with screw threads;
the first guide rail is fixed on the first stepper motor, the first sliding block and the first guide rail are in threaded connection, and the first stepper motor is configured to drive the first guide rail to rotate so as to mobilize the first sliding block to slide on the first guide rail;
the second sliding device comprises a second stepper motor and a second sliding block, and both the second sliding block and the second guide rail are provided with screw threads; and
the second stepper motor is fixed on the first sliding block, the second guide rail is fixed on the second stepper motor, the second sliding block and the second guide rail are in threaded connection, and the second stepper motor is configured to drive the second guide rail to rotate so as to mobilize the second sliding block to slide on the second guide rail.

8. A laser marking machine, comprising: a supporting rack, a marking platform, and a laser marking head;
the laser marking head comprising:
a laser generator, the laser generator being configured to emit laser;
a first guide rail;
a first sliding device, the first sliding device being sleeved on and being capable of sliding on the first guide rail;
a first reflector, the first reflector being positioned on the first sliding device;
a second guide rail, the second guide rail being fixed on the first sliding device and being perpendicular to the first guide rail;
a second sliding device, the second sliding device being sleeved on and being capable of sliding on the second guide rail; and
a second reflector, the second reflector being positioned on the second sliding device;
wherein, in use, the laser emitted from the laser generator is parallel to the first guide rail and incident on the first reflector, the first reflector reflects the laser to the second reflector, the laser reflected from the first reflector is parallel to the second guide rail, and the second reflector reflects the laser downward for location and marking;
the marking platform is configured to support an object to be marked, both the laser marking head and the marking platform are positioned on the supporting rack, the laser marking head is positioned above the marking platform, and the laser emitted downward from the laser marking head is incident on the marking platform.

9. The laser marking machine according to claim 8, wherein
the first guide rail of the laser marking head is parallel to Y axis of the marking platform;
the second guide rail of the laser marking head is parallel to X axis of the marking platform; and
the laser emitted downward from the laser marking head is perpendicular to the marking platform.

10. The laser marking machine according to claim 8, wherein
the laser marking machine further comprises a lifting device; and
the lifting device is positioned on the supporting rack, the marking platform is positioned on the lifting device, and the lifting device is configured to raise or lower the marking platform.

11. The laser marking machine according to claim 8, wherein inner sides of the first sliding device and the second sliding device of the laser marking head are provided with grating rulers, respectively.

12. The laser marking machine according to claim 8, wherein
the first sliding device comprises a first stepper motor and a first sliding block, and both the first sliding block and the first guide rail are provided with screw threads;
the first guide rail is fixed on the first stepper motor, the first sliding block and the first guide rail are in threaded connection, and the first stepper motor is configured to drive the first guide rail to rotate so as to mobilize the first sliding block to slide on the first guide rail;
the second sliding device comprises a second stepper motor and a second sliding block, and both the second sliding block and the second guide rail are provided with screw threads; and
the second stepper motor is fixed on the first sliding block, the second guide rail is fixed on the second stepper motor, the second sliding block and the second guide rail are in threaded connection, and the second stepper motor is configured to drive the second guide rail to rotate so as to mobilize the second sliding block to slide on the second guide rail.

13. The laser marking machine according to claim 8, wherein
the laser marking head further comprises a focusing lens; and
the focusing lens is positioned on the second sliding device and located below the second reflector, and the focusing lens is configured to focus the laser reflected from the second reflector.

14. A laser marking machine, comprising: a supporting rack, a marking platform, and a laser marking head;
the laser marking head comprising:
a first guide rail;
a first sliding device, the first sliding device being sleeved on and being capable of sliding on the first guide rail;
a second guide rail, the second guide rail being fixed on the first sliding device and being perpendicular to the first guide rail;
a second sliding device, the second sliding device being sleeved on and being capable of sliding on the second guide rail;
a laser generator; and
a reflector, both the reflector and the laser generator being positioned on the second sliding device;
wherein, in use, laser emitted from the laser generator is incident on the reflector, and the reflector reflects the laser downward for location and marking;
the marking platform is configured to support an object to be marked, both the laser marking head and the marking platform are positioned on the supporting rack, the laser marking head is positioned above the marking platform, and the laser emitted downward from the laser marking head is incident on the marking platform.

15. The laser marking machine according to claim 14, wherein
the first guide rail of the laser marking head is parallel to Y axis of the marking platform;
the second guide rail of the laser marking head is parallel to X axis of the marking platform; and
the laser emitted downward from the laser marking head is perpendicular to the marking platform.

16. The laser marking machine according to claim 14, wherein
the laser marking machine further comprises a lifting device; and
the lifting device is positioned on the supporting rack, the marking platform is positioned on the lifting device, and the lifting device is configured to raise or lower the marking platform.

17. The laser marking machine according to claim 14, wherein inner sides of the first sliding device and the second sliding device of the laser marking head are provided with grating rulers, respectively.

18. The laser marking machine according to claim 14, wherein
the first sliding device comprises a first stepper motor and a first sliding block, and both the first sliding block and the first guide rail are provided with screw threads;
the first guide rail is fixed on the first stepper motor, the first sliding block and the first guide rail are in threaded connection, and the first stepper motor is configured to drive the first guide rail to rotate so as to mobilize the first sliding block to slide on the first guide rail;
the second sliding device comprises a second stepper motor and a second sliding block, and both the second sliding block and the second guide rail are provided with screw threads; and
the second stepper motor is fixed on the first sliding block, the second guide rail is fixed on the second stepper motor, the second sliding block and the second guide rail are in threaded connection, and the second stepper motor is configured to drive the second guide rail to rotate so as to mobilize the second sliding block to slide on the second guide rail.
